(19) United States
(12) Patent Application Publication
(10) Pub. No.: US 2014/0305209 A1
(43) Pub. Date: Oct. 16, 2014

(54) Apparatus to measure the speed at which, wheels in rotation present an appearing rotation speed inversion, the so called wagon wheel effect, with either one or two independent disks in rotation with various spokelikepatterns, and considering further characteristics specific to our design

(71) Applicant: Olivier L Dehousse, New York, NY (US)

(72) Inventor: Olivier L Dehousse, New York, NY (US)

(21) Appl. No.: 13/986,194

(22) Filed: Apr. 11, 2013

(51) Int. Cl. G01P 3/46

(52) U.S. Cl. CPC G01P 3/465
USPC 73/509; 700/304

(57) ABSTRACT

The so-called “wagon wheel effect”, which our apparatus produces and measures under specific conditions which we have designed, appears when the visual superposition of (elements of) disks in motion, observed with one or two eyes, reaches a speed, at which normal brain processes perceive as a rotation speed inversion. We present an apparatus and a method allowing for various parameters measuring various conditions to be considered (such as rotation speed, lightning intensity, disk patterns variable in colors, in sizes, in symmetry and in their ability to reflect light—matt or glossy) to support the establishment of a normative theory and measure specific populations (aging population, individuals suffering from mental illness such as Alzheimer, possibly in their early stage of development) against this norm.

### BACKGROUND OF THE INVENTION

1. Field of Invention

Our invention consists of an apparatus, which can reproduce under measurable conditions, as defined per our design, an experiment called the wagon wheel effect—at specific rotation speeds, a wagon wheel appears to rotate in a direction opposite to the real one—, and a method, consisting of collecting the measurements collected under various conditions to establish a norm, and allow for different populations, for instance aging populations or individuals suffering from nervous degenerative diseases, such as Alzheimer, possibly in their early stage of development, to be compared against this norm. As the one or the two disks of our apparatus, presenting spokelike patterns, rotate at an increasing speed, a disk rotation inversion will appear to an observer, according to an engineering signal theory called Shannon-Nyquist theory (or frequency). It is this maximum speed, which our apparatus is aimed to measure.

2. Related Background Arts

One important aspect of this invention is to realize that, in a pure Shannon-Nyquist context, and if such theory was applicable to the brain, an observer would see multiple inversions of a rotating disk, presenting spoke patterns, at increasing speed. However, we believe that the brain makes corrections to the signal, to only “present” one inversion in speed, while such disk continues to rotate at increasing speed. It is one of the reasons why the measurement of this speed is the focus of our interest here. Such inversion is often called the wagon wheel effect in the scientific literature. To simplify the reading of our application, we also refer here to the wagon wheel effect. It is important to note that this effect, as we mean it, is no different than what we meant in relation to the Shannon-Nyquist theory and maximum frequency, an engineering signal theory, which defines the required minimum sampling frequency, to correctly convert a periodical signal from analog to digital. The wagon wheel inversion effect can often be observed either in real life or on television, for instance during bicycle races. In the context of our invention, when this phenomena is observed on television, it is important to notice that, we believe, the conditions are biased by the sampling frequency of the camera, and the rendering of the signal on a television (see the various sampling frequencies coming into play). Other scientific publications refer to this experiment, as the result of either a discrete, or a continuous sampling process (in fact, it is probably neither . . . nor but instead of combination of them), or present computer simulation models, which under our assumptions, introduce important biases, specific to fundamental aspects of the effect. Some of these biases are (but not limited to) the dissymmetry introduced by some monitor screen resolution, brightness limitations, or unexpected variations in the rendering of a uniform motion (either under constant speed or constant acceleration), inherent in the way computers work. Such biases constitute in our opinion as many obstacles to measuring, or reproducing the phenomena, with a necessary accuracy, as we would need. Our invention is designed to produce the effect, in its most fundamental form, and allow it to be reproducible to match conditions, akin to those required for a scientific approach. Our review of previous arts shows, that in all of them, the fundamental prerequisites, which we need, are missing. U.S. Pat. No. 3,505,750 claims to reproduce the effect, without being able to provide any measurements, such as the measurement of an accurate inversion rotation speed, and introduces an additional moving grid, which we see as a potential source of bias. U.S. Pat. No. 1,942,006 refers to the phenomena, under similar limiting assumption, as an entertainment device. U.S. Pat. No. 5,738,587 teaches some elements of our invention, but without focusing on aspects, that we consider fundamental, such as rotation speed measurement, and control over uniform lightning conditions; all prerequisites to analyze the effect accurately, and do not rely, on fundamental aspects of psychophysics, such as lightning intensity, and effect of colors, treated differently by different types of eye cells. The size of the rotating disks used here can be modified, to allow further sensitivity in the speed measurement of the so-called wagon wheel effect, as the speed of the image in motion (in our case a disk presenting various spokelike patterns) is also function of its distance to the center. Furthermore, former arts do not mention additional aspects of our experiment such as, for instance, on one hand, the dependence between the level of symmetry of a disk presenting spokelike patterns under specific lighting, and the inversion speed, or, on the other hand, the fact that the introduction of tinny marks of asymmetry in the disk patterns, may modify the measurement of the appearing inversion speed. Other aspects of the effect will also be studied, such as for instance, the fact that only one inversion, and not multiple inversions, is taking place, to the contrary of what could be expected for any usual discrete sampled signal. This aspect is fundamental, and also, a main reason for introducing our application.

To further support the need for our method, an additional evidence sufficient to support an effective theory, is the fact that for various groups of a population, the speed at which the inversion takes place should differ enough for a statistical variation to be measured (assuming appropriate sensitivity). For instance, the wagon wheel effect can occur using one or two eyes, probably with different results. These characteristics are likely sensitive to alcohol consumption—brain processes seem to be impacted in the context of interpreting even slow moving images under strong alcohol influence—and also to aging. Furthermore, common characteristics among younger drivers or among young persons in general, which differentiate them from older drivers or old persons, could also be seen as another potential assumption for an effective theory as described above. Under alcohol influence, the multiplexing of large pieces of information impressed, and superposed in the brain seems to slow down, which in some cases seems also to provide comfort and relaxation. (Higher definition TVs providing more stable images may impact our perception, and increase our comfort level in a similar way). On a similar train of thoughts, in other areas of sciences, assumptions about evolutionary theories, in specific when related to the way homo sapiens were hunting, may also suggest that a higher capacity to analyze images in motions have played an important role during the human evolution, and might have also been among the first signs, precursors of the development of a more elaborated intelligence in human being. In addition, one could believe that, the brain is sending reward “signals” while analyzing images in motions—as our society is so much based on various aspects of motions, and on our capability to analyze motions, in practicing or watching usual sports for instance. (We purposely leave side consideration about the animal world away from our focus at this moment, which we assume is also applicable to the outcome of our inventions).

To further highlight some of our assumptions, there is an obvious learning aspect to this function, as in many other brain functions, for instance among racing pilots.

It is also reasonable to assume that brain processes involved with the wagon wheel effect requires the “multiplexing” of huge amount of information originating from on one eye, or from two eyes, to produce this one single inversion. Therefore, it must involve highly sensitive and extremely complex brain processes, subject to many unknown external influences, some of which, we are presenting here.

Our invention will help to explore, and provide the basic foundations for a normative theory, which today, and according to the author's research, does not exist.

New technology, such as fMRI (or functional magnetic resonance imaging using tracers to identify active area of the brain during specific tasks) makes possible to establish the dependencies between psychological processes, and their physical locations in the brain. Our experiment could also be reproduced in an MRI, allowing for instance to analyze the overlap of regions in activity, when the brain is processing images in motion—of which a limit is the wagon wheel effect speed—, and when the brain is processing static images, and if so, according to what principles one supersedes the other, and how other centers of the brain relate to one, and the other (emotions, memory, etc . . . ).

### CROSS-REFERENCE

The provisional patent application (same owner) U.S. 61/465,772 is a related patent. It was introduced as a provisional patent, which foundations use the same principles as here.

### BRIEF DESCRIPTION OF THE DRAWINGS

FIG. 1 in the accompanying drawing illustrating our embodiment of the invention is a schematic view of all the components along with one rotating disk, (One should note that our apparatus consists of two disks and therefore most of these components will need to be duplicated for our second disk).

FIG. 2 is a representation of the electrical circuit required for the functioning and control of our apparatus and the measurement of all the conditions that are here of interest in our case.

FIG. 3 shows a disk comprising various patterns, as an example of those that we will be using. It shows also an adjustable form, designed to further enhance the measurement of the effect, and provide a more accurate measurement of the rotation speed.

FIG. 4 shows some variations on the pattern which we will be using also, highlighting the use for multiple degrees of symmetry.

FIG. 5 shows a representation of our apparatus in 3D.

FIG. 6 indicates that either one of the rotating disks can be used or both rotating disks can be used independently and at the same time in our apparatus.

### DETAILED DESCRIPTION OF THE EMBODIMENT

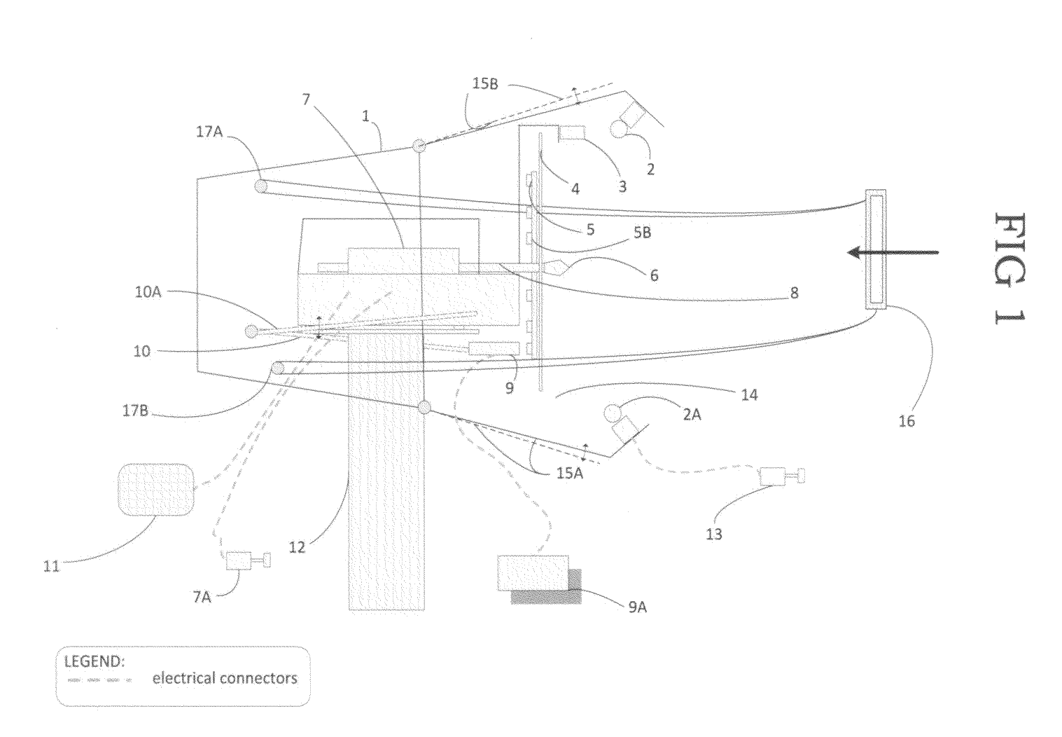

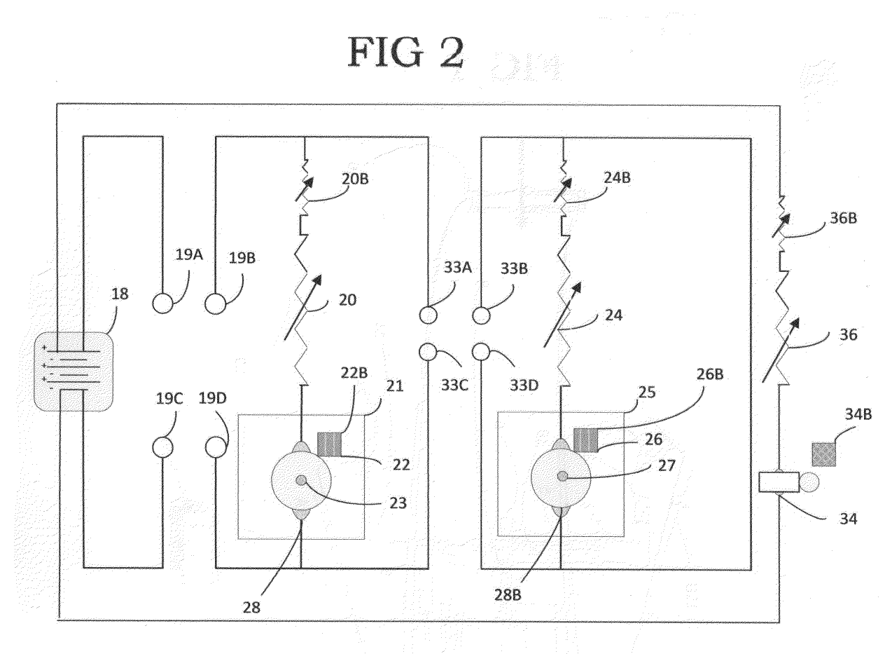

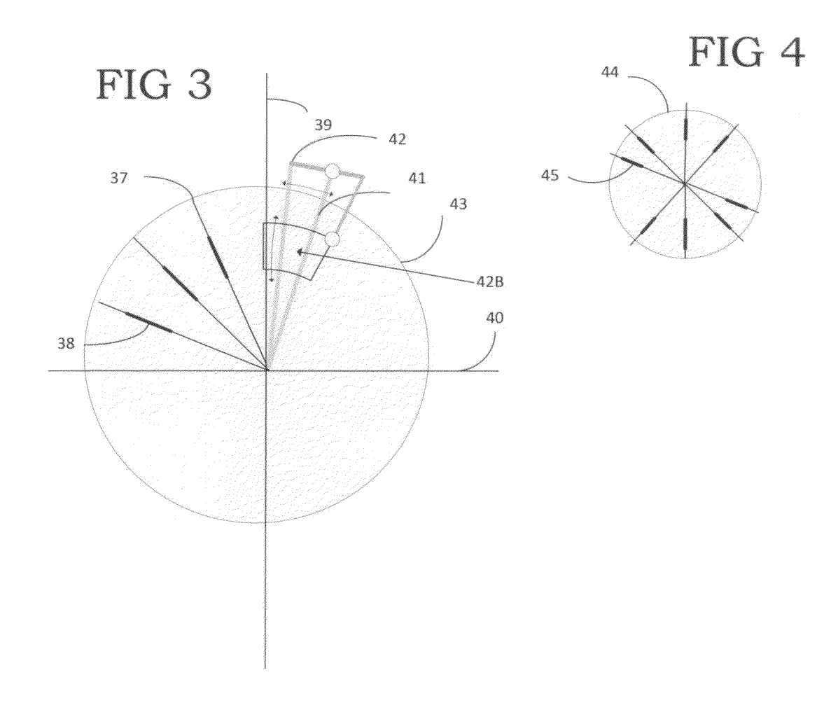

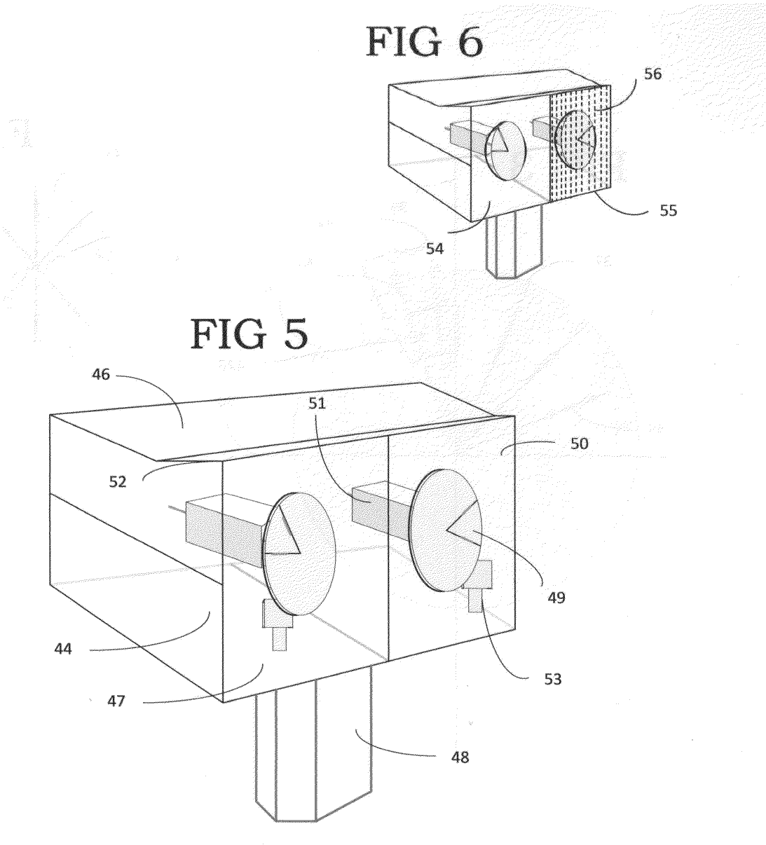

FIG. 5 and FIG. 6 represent a simplified 3D view of our apparatus, which includes two disks capable of rotating independently across a large range of measurable speeds. An observer is maintained at a specific distance from the disks in using an open form 16 attached to an extension, itself attached to the housing of our machine at points 17A and 17B on the FIG. 1. The combination of the open form and the extension are used to maintain an observer directly in front of the two rotating disks and at a specific distance from them. FIG. 5 and FIG. 6 show a simplified 3D representation of our apparatus with the two disks as seen by an observer. A screen 41 can be placed in front of either rotating disk to prevent from being seen by an observer, and can further be moved to the left side 42A or the right 42B at any time. The housing 1 is comprised of an adjustable stand 12, which allows for a comfortable positioning of the apparatus and the observer. Furthermore, the position of the disks will always be centered and face the observer's face is in perfect horizontal alignment with an observer's view as showed by the arrow on FIG. 1. This position can also be adjusted such as one side of each shaft forms a small angle with an horizontal positioning. A simple mechanism is provided to elevate a side of the disks' shafts and create this angle 10 and 10A. Two electrical motors 7, side by side, included in the housing, are respectively connected to a shaft 8, which via a simple compound gear system, rotates with their respective motors. At the end of each of these shafts, there is a circular support 4 used to attach various disks, variable in size, in color, in spokelike patterns, in thickness and in their capacity to reflect light—matt or glossy finish. The type of motors preferred is DC as this type of electrical motor offers a better and easier control over speed by the use of a potentiometer 9 to regulate the voltage at their armature. The external source of DC electrical power is also represented in 11.

The housing of our apparatus is capable to adjust to different sizes of disks in using moveable superior 15A and inferior 15B walls. Each shaft 8 is terminated by a knob 6 to attach the various disks to the front side of the circular support 4 itself attached to the motor. On the opposite side of the rotating circular support, multiple small reflective elements 5 can be added along the circumference of each disks at regular angles to reflect light (infrared preferred) emitted by the tachometer source 8. Each source (respectively for each disk) is capable to count the number of refection of the light per unit of time as the disk is in rotation, and as such to provide an accurate measurement of the disk rotation angle per unit of time at any time. The accuracy of the speed measured can be increased by increasing the number of these reflective elements 5 capable to reflect the infrared light. In our simplified embodiment, the mechanism provided to measure the speed, the tachometer, comprising of a source 8 and the reflecting elements 5, has its own power generator (It is using internal battery). A screen connected to the tachometer 8A is included to show an accurate measurement of the rotation speed when the rotation inversion—the so-called wagon wheel effect—takes place for an observer. To measure variable conditions in which the effect takes place, a system comprised of a control over light intensity is also included, consisting of sources of light 2 and 2A and potentiometers 13 controlling their light intensity. The light intensity can be measured with a light meter 3, providing a measurement of the lightning conditions in which the experiment takes place, which needs to be uniform over the two entire disks surface.

The source of DC current 18 alimenting the two armatures 28 and 28B of the two DC electrical motors can be inverted with a switch connecting the contacts 19 A D and 19 BC to become 19 AC and 19 BD. Another similar switch placed between the two motors connecting the contacts 33 AD and 33 BC can become 33 AB and 33 CD allows to change the rotation direction of the two motors and the motors' shafts, respectively showed in 23 and 27. The two motors 21 and 25 are confined in a single housing as presented in 34 (FIG. 5). Two series of potentiometers different in size 20 and 20B and 24 and 24B allow for the gradual adjustment of the rotation speed and its accurate measurement when the wagon wheel effects takes place. Two independent tachometers 22 and 26 connected to a screen are respectively place at the extremity of each circular support to measure each rotation speed independently. Another circuit enables to control the light 34, intensity and lightning environment with dual potentiometers 36 and 36B. These lightning conditions can also be measured any time with the appropriate light meter 34B.

The rotating disks designed to produce the wagon wheel effect present spokelike patterns 43 and 44 with various levels of symmetry, which is important in the context of the use of our apparatus, (a higher levels of symmetry will produce the wagon wheel effect at a lower rotation speed for a same observer). The spokes designed on the disks will present different thickness 37 and 38 sometimes even in specific areas of the spoke. The spokes 28 designed on a disk, as well as these thicker areas can also be drawn in different colors (because different types of eye cells react differently to different colors) and in a material capable to reflect the light differently (matt or glossy finish). A variable form 42 which goal is for an observer to focus on a specific band region (area of interest) of the rotating disk is also part of our apparatus. This variable form is attached to superpose the disk and remain static during the experiment while the disk is rotating. As the area of interest become smaller with the adjustment of the triangular surface 42, the appearing speed rotation inversion becomes conis restricted to the area of interest and adds accuracy to the measurement. As such the reduced area of interest can further limit the view of an observer in focusing on a specific band on each disk, in modifying the band's distant to the center of the disk, itself directly proportional to the speed, as showed by the arrow 42B. Finally, this form has one edge centered around the shaft and two vertices of equal size which can be moved apart or brought back together to increase or decrease the rectangular area.

A simplified version of our apparatus in 3D is in FIG. 5 and FIG. 6 and shows the housing 46, the superior moving wall 52 allowing for large disks to be inserted in the machine, and an adjustable stand 48. FIG. 5 shows also the two disks and their respective electrical motors, to which there are connected via a shaft. Our apparatus allows for one disk and two disks to rotate independently 54 and 55. An opaque screen 56 can be used to block the view of either the left or the right rotating disk at any time.

### SUMMARY OF THE INVENTION

In accordance with our present invention, a machine for accurately measuring the rotation speed of either one disk or two disks, rotating at independent speed and in independent direction, measuring the conditions per our design at which the so-called wagon wheel effect takes place. Our apparatus is designed to eliminate most of the obvious biases around the so-called wagon wheel effect and its producing. Our machine includes two disks respectively connected to two electrical motors, which rotation speed and rotation direction can be controlled independently. The housing allows for various disks in size and with different patterns to be used for producing and measuring the conditions at which the effect, the so-called wagon wheel effect, takes place for an observer maintained at a specific distance from the disks. The design of our machine is made with respect to all aspects per our design required to establish a scientific analysis of the effect across multiple populations consisting of normal individuals or individuals suffering from specific conditions (short or long term) or diseases, for instance nervous degenerative diseases such as Alzheimer, advanced or in their early stages. Our long-term goal is to provide an apparatus which can be used to establish a normative theory about the wagon wheel effect, which today does not exist, and to measure specific populations (aging population, individuals suffering from mental illness such as Alzheimer, possibly in their early stage of development) against this norm.

I claim:

1. An apparatus for producing and measuring accurately, in specific conditions, the speed at which the so-called “wagon wheel effect” is produced—at specific speed(s), a wagon wheel appears to rotate in a direction opposite to the real one—with two independent rotating disks, presenting various spokelike patterns, under specific conditions of light and colors, comprising:
a. A housing comprising:
i. Two disks capable to rotate independently across a wide range of speeds which can be accurately controlled, adjustable in sizes, in colors, in material reflecting light intensity, presenting various spokelike patterns.
ii. An embedded tachometer allowing the measurement of the disks' speed with accuracy at any time, and allowing the reading of such speeds at any time.
iii. An embedded system producing uniform light, variable in intensity, across the disks at any time and a light meter accurately measuring the light intensity at any time.
iv. An embedded mechanism to consistently position our apparatus against an observer.

2. The machine of claim 1 further comprising an accurate mechanism of speed control used for the two rotating disks, capable to accurately control the two disks independently in speed and in direction, and to measure it wherein:
a. Potentiometers of various sizes and sensitivity can accurately control the speed in controlling the voltage on the armature of electrical motors.
b. Switches allow the inversion of the respective difference in voltages on the armature of the electrical motors, independently of the source of current used.
c. Reflective elements, part of the embedded tachometer system, placed at regular angles along each of the circular support of each of the disks, which count can be increased and therefore increase the sensitivity of the speed measurement and give an accurate measurement of the rotation speed in angle (degrees) per second.

3. The machine of claim 1 further comprising a sensitive mechanism consisting of potentiometers producing a uniform lightning environment, uniform on and in the surrounding of the two disks variable in size, and allowing with the support of a light meter to measure the light intensity accurately at any time.

4. The machine of claim 1 further comprising of an extension allowing for the specific positioning of an observer in front of one or the two disks in rotation and at specific consistent distance from these disks, which further sets the distance separating our apparatus from an observer.

5. The machine of claim 1 further comprising disks presenting spokelike patterns, with spokes of various thicknesses, various levels of symmetry, various sizes, various colors and using various materials capable to reflect the light intensity differently.

6. The machine of claim 1 further comprising an adjustable area, in turn defining a specific area of focus on each rotating disks, which surface can increase or decrease in moving apart or bringing together the two vertices, and an upper and lower limit restraining the view of the adjustable disk area to a specific band to further refine the speed measurement.

7. A method consisting of measuring accurately all characteristics presented per our design to create a norm and to measure various populations against such norm. Such populations should comprise aging populations, populations under the effect of short or long term conditions such as induced by alcohol consumption, or suffering from diseases, such as Alzheimer or other degenerative nervous diseases, possibly in their respective early stages of development.
